(19) United States
(12) Patent Application Publication
(10) Pub. No.: US 2025/0249724 A1
(43) Pub. Date: Aug. 7, 2025

(54) CONTROL SYSTEM FOR VEHICLE AIR VENT

(71) Applicants: Hyundai Motor Company, Seoul (KR); Kia Corporation, Seoul (KR)

(72) Inventors: Jae Won HEO, Seoul (KR); Sang Shin LEE, Seoul (KR); Sang Yeop LEE, Seoul (KR)

(73) Assignees: Hyundai Motor Company, Seoul (KR); Kia Corporation, Seoul (KR)

(21) Appl. No.: 18/815,477

(22) Filed: Aug. 26, 2024

(30) Foreign Application Priority Data
Feb. 6, 2024 (KR) 10-2024-0018137

(51) Int. Cl. B60H 1/00

(52) U.S. Cl. CPC B60H 1/00742; B60H 1/0073; B60H 1/00871

(57) ABSTRACT

A control system for vehicle air vents includes a main vent positioned in a vehicle and configured to discharge air, an assistant vent positioned over the main vent, and a controller configured to drive the main vent, wherein the controller is configured to determine heat load data generated in the vehicle, adjusts an angle of the main vent, and adjusts the angle of the assistant vent based on a blowing direction of the main vent.

### CROSS REFERENCE TO RELATED APPLICATION

The present application claims priority to Korean Patent Application No. 10-2024-0018137, filed Feb. 6, 2024, the entire contents of which is incorporated herein for all purposes by this reference.

### BACKGROUND OF THE PRESENT DISCLOSURE

### Field of the Present Disclosure

The present disclosure relates to a control system for vehicle air vents, that is, a control system that controls the blowing direction of vehicle air vents based on the state information of a driver or passengers in the vehicle and an image of the interior of the vehicle.

### Description of Related art

In general, an air conditioning system is mounted inside the crash pad in a vehicle and configured to perform cooling and heating by suctioning external air or blowing internal air into the vehicle and make a pleasant environment in the vehicle by ventilating the interior. Such an air conditioning system controls the temperature in a vehicle to a set temperature when an Auto switch or a Temp switch of a Full Auto Temperature Control (FATC) is operated.

In the present configuration, warm air and cool air are supplied into a vehicle by controlling a mode door based on sensing by various sensors.

When sensors mounted at a several positions in a vehicle sense and transmit an internal air temperature, an external air temperature, the temperature of an evaporator, the quantity of solar radiation, internal humidity, and an internal contamination state to an ATC controller, the FATC is controlled by the ATC controller to discharge air into the vehicle while adjusting the blowing speed of a blower, determining whether to operate an air conditioner, and adjusting doors in a unit, maintaining the interior of the vehicle in a pleasant state.

For example, a sensor that detects the temperature of internal air is mounted on a side of the center instrument panel at the right side of a driver and can detect the internal temperature of the vehicle and a sensor that detects the temperature of external air is mounted at the center portion in front of the radiator of a vehicle and can detect the temperature of external air.

When an internal temperature, a blowing volume, a blowing mode, etc. set by a user are selected and these sensors detect the temperature of internal air and the temperature of external air, an FATC control unit compares the detected temperatures of internal air and external air and the temperature set by the user and is configured to perform temperature control to maintain an optimal blowing volume and internal temperature.

In the instant case, for the blowing volume, blowing stages are controlled through a blowing volume controller based on blowing volumes set by a user.

Furthermore, whether to operate a heater or an air conditioner is determined and the heater or the air conditioner is controlled based on a temperature measured by a temperature sensor and a user setting temperature set in a user setting unit.

However, when such as FATC control unit of the related art is used, there is the defect that it is necessarily required for a user to set an environment.

For example, to operate an FATC, a user has to set a desired internal temperature and set a blowing volume or a blowing mode.

For example, there are various stages of a first stage to a fourth stage for a blowing volume and a user has to set a blowing mode too into desired directions from various modes of VENT, BI-LEVEL, FLOOR, MIX, etc.

Accordingly, there is the defect that such setting is very troublesome to users.

Furthermore, a main vent for discharging warm air and cool air is positioned toward the middle portion or the lower portion of a driver, so there is a problem that it is difficult to target the main vent at the driver's face. Furthermore, an assistant vent is positioned behind a monitor that outputs the state of a vehicle and a navigation, so there is a problem that the blowing direction is greatly limited.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to determining heat load by collecting the state information of all of occupants in a vehicle and internal image data of the vehicle, for adjusting the angle of a main vent, and for adjusting the blowing direction of an assistant vent based on angle adjustment of the main vent.

An objective of the present disclosure is to provide a control system for vehicle air vents, the control system configured to solve all of the problems that were generated due to the installation positions of a main vent and an assistant vent in the related art.

The objectives of the present disclosure are not limited to those described above and other objectives not stated herein may be understood through the following description and may be made clear by embodiments of the present disclosure. Furthermore, the objectives of the present disclosure will be achieved by the configurations described in claims and combinations thereof.

To achieve the objectives of the present disclosure described above, a control system for vehicle air vents includes the following configuration.

According to an exemplary embodiment of the present disclosure, the control system for vehicle air vents includes: a main vent positioned in a vehicle and configured to discharge air; an assistant vent positioned over the main vent; and a controller configured to drive the main vent, wherein the controller is configured to determine heat load data generated in the vehicle, adjusts an angle of the main vent, and adjusts the angle of the assistant vent based on a blowing direction of the main vent.

According to an exemplary embodiment of the present disclosure, the controller of the control system for vehicle air vents may collect heat load data through at least one of an infrared camera and a visible light camera.

According to an exemplary embodiment of the present disclosure, the controller of the control system for vehicle air vents may use at least one of an in-cabin monitoring system or a driver monitoring system.

According to an exemplary embodiment of the present disclosure, the controller may collect state information by measuring temperatures of faces and body portions of occupants in the vehicle using an infrared camera and may collect internal image data of the vehicle using a visible light camera.

According to an exemplary embodiment of the present disclosure, the controller of the control system for vehicle air vents may include: an acquiring processor configured to obtain state information of occupants in the vehicle and image data of the vehicle using at least one of an infrared camera and a visible light camera; a learning processor configured to determine and learn whether heat load has been generated from the state information and the image data obtained from the acquiring processor; and an operating processor configured to adjust the angle of the main vent based on heat load data and adjust the angle of the assistant vent based on the angle of the main vent.

According to an exemplary embodiment of the present disclosure, the controller of the control system for vehicle air vents may further include: a control processor configured to drive the operating processor and to control data flow between the acquiring processor, the learning processor, and the operating processor, and a communication processor configured to communicate with an external device.

According to an exemplary embodiment of the present disclosure, the learning processor of the control system for vehicle air vents may collect data as a learning model that utilizes any one algorithm of a Convolution Neural Network (CNN) algorithm, a machine learning algorithm, or a deep learning algorithm.

According to an exemplary embodiment of the present disclosure, the learning processor of the control system for vehicle air vents may extract feature values from the state information, the image data, and the heat load data obtained from the acquiring processor, and may store and use the feature values as previously stored data.

According to an exemplary embodiment of the present disclosure, the state information of the control system for vehicle air vents may include at least one of the number of times of blinking of an occupant, an open size of eyelids, or a movement speed of eyelids.

According to an exemplary embodiment of the present disclosure, the state information of the control system for vehicle air vents may include heart rate (HR) information of an occupant obtained from the acquiring processor and the heart rate information includes a heart rate variability (HRV) signal.

According to an exemplary embodiment of the present disclosure, the state information of the control system for vehicle air vents may include information recognizing a posture and a behavior pattern of an occupant, and sensing and a position of an object.

According to an exemplary embodiment of the present disclosure, the main vent of the control system for vehicle air vents may include: a main wing being a blade positioned in a discharge port configured to discharge air to determine a direction of air; a main gear engaged to the main wing and configured to rotate the main wing; a main actuator coupled to the main gear and electrically connected to the controller and configured to drive the main gear; and a main lever coupled to the main wing and the main gear and configured to rotate the main wing by driving of the main actuator, and the angle of the main vent may be adjusted by an electrical signal from the controller.

According to an exemplary embodiment of the present disclosure, the main wing of the main vent of the control system for vehicle air vents may include: at least one or more vertically disposed longitudinal wings; and a transverse wing transversely connecting the at least one or more vertically disposed longitudinal wings.

According to an exemplary embodiment of the present disclosure, the assistant vent of the control system for vehicle air vents may include: an assistant wing being a blade positioned in a discharge port configured to discharge air to determine a direction of air; an assistant gear coupled to the assistant wing and configured to rotate the assistant wing; an assistant actuator coupled to the assistant gear and electrically connected to the controller and configured to drive the assistant gear; and an assistant lever coupled to the assistant wing and the assistant gear and configured to rotate the assistant wing by driving of the assistant actuator, and the angle of the assistant vent may be adjusted based on the angle of the main vent.

According to an exemplary embodiment of the present disclosure, it is possible to achieve the following effects from the configuration, combination, and operation relationship to be described below.

The present disclosure is for determining heat load by collecting the state information of occupants in a vehicle and internal image data of the vehicle, for adjusting the angle of a main vent, and for adjusting the blowing direction of an assistant vent based on angle adjustment of the main vent.

According to an exemplary embodiment of the present disclosure, it is possible to target a main vent at the face of a driver and a driver does not need to set a blowing volume, a blowing direction, or a blowing mode in person because the angle of an assistant vent connected to the main vent is automatically adjusted.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view showing the entire of a control system for vehicle air vents according to an exemplary embodiment of the present disclosure;

FIG. 2A and FIG. 2B are views showing a main vent of the control system for vehicle air vents according to an exemplary embodiment of the present disclosure;

FIG. 3A and FIG. 3B are views showing an assistant vent of the control system for vehicle air vents according to an exemplary embodiment of the present disclosure;

FIG. 4 is a block diagram showing the configuration of the control system for vehicle air vents according to an exemplary embodiment of the present disclosure;

FIG. 5 is a flowchart sequentially showing the order of driving the control system for vehicle air vents according to an exemplary embodiment of the present disclosure; and

FIG. 6A and FIG. 6B are views schematically showing an example in which the control system for vehicle air vents according to an exemplary embodiment of the present disclosure is driven.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. Embodiments of the present disclosure may be modified in various ways and the scope of the present disclosure should not be construed as being limited to the exemplary embodiments to be described below. The exemplary embodiments are provided to more completely explain the present disclosure to those skilled in the art.

Terms ‘˜er’, ‘˜unit’, ‘˜module’, etc. used herein mean the units for processing at least one function or operation and may be implemented by hardware, software, or a combination of hardware and software.

Terms used in an exemplary embodiment of the present disclosure are used only to describe predetermined exemplary embodiments rather than limiting embodiments. Singular forms are intended to include plural forms unless the context clearly indicates otherwise.

The terms indicating directions such as ‘up (upward)’, ‘down (downward)’, ‘left and right (side or lateral)’, ‘front (forward)’, and ‘rear (rearward)’ stated in the specification, claims, etc. are defined based on relative positions of figures or configurations for the convenience of description without limiting the right of the present disclosure, and the directions to be described hereafter are based on the present fact except for the case when they are limited otherwise.

Hereinafter, various exemplary embodiments are described in detail with reference to accompanying drawings, and in the following description of the accompanying drawings, like reference numerals are provided to like components and repetitive description is omitted.

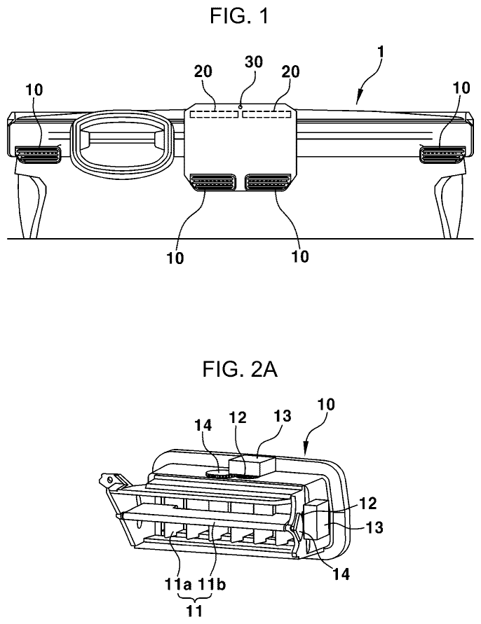

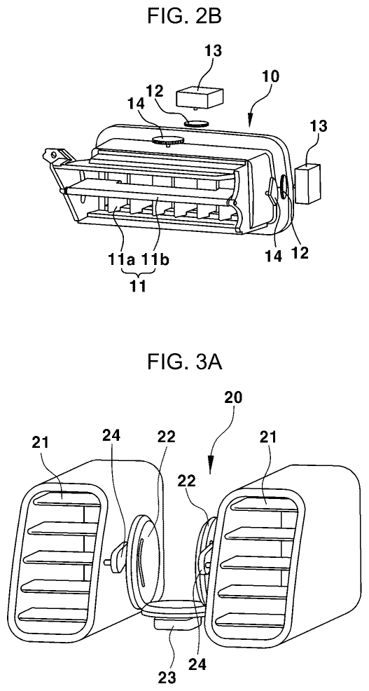

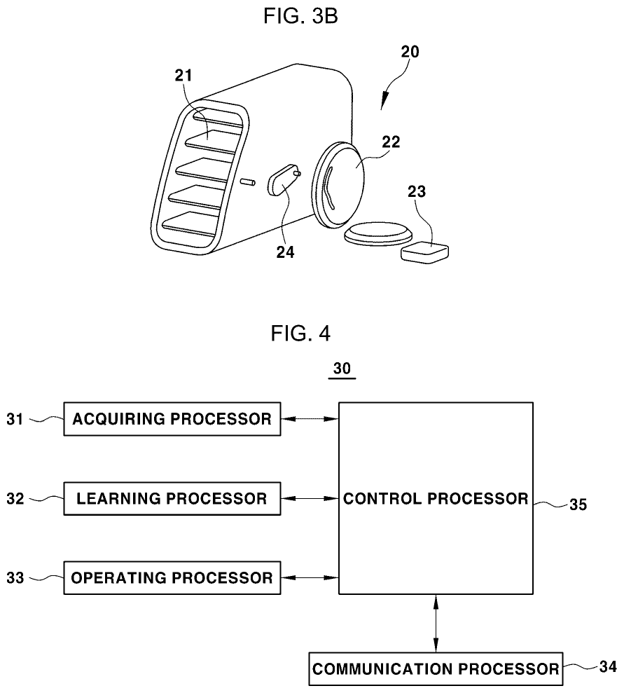

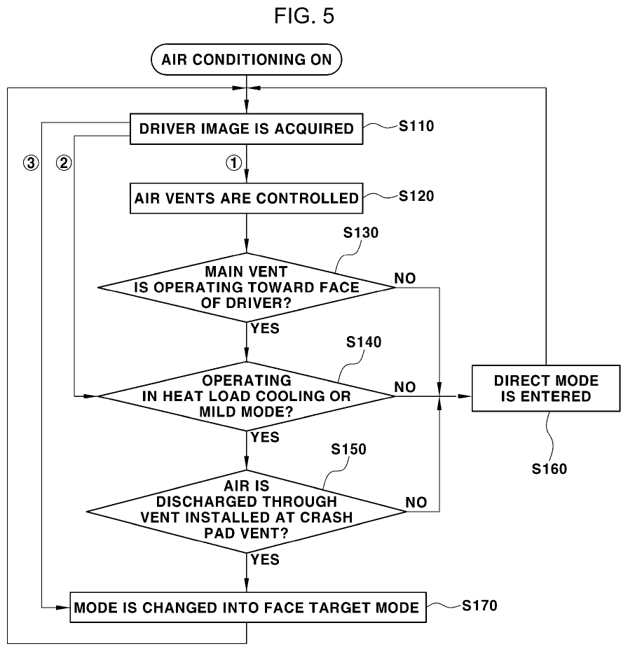

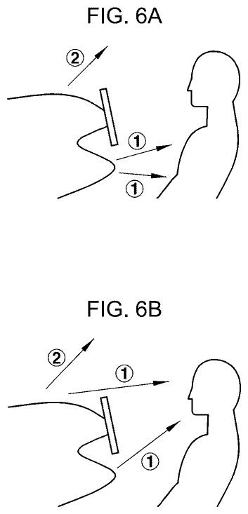

FIG. 1 is a view showing the entire of a control system for vehicle air vents according to an exemplary embodiment of the present disclosure, FIG. 2A and FIG. 2B are views showing a main vent of the control system for vehicle air vents according to an exemplary embodiment of the present disclosure, FIG. 3A and FIG. 3B are views showing an assistant vent of the control system for vehicle air vents according to an exemplary embodiment of the present disclosure, FIG. 4 is a block diagram showing the configuration of the control system for vehicle air vents according to an exemplary embodiment of the present disclosure, FIG. 5 is a flowchart sequentially showing the order of driving the control system for vehicle air vents according to an exemplary embodiment of the present disclosure, and FIG. 6A and FIG. 6B are views schematically showing an example in which the control system for vehicle air vents according to an exemplary embodiment of the present disclosure is driven.

First, the present disclosure relates to air vents for vehicles, which mean pipelines such as ducts for discharging air (cold air or warm air) conditioned through Heating, Ventilation, Air Conditioning (HVAC) of an automotive air conditioning system to the interior of a vehicle through a distributor and perform a function of maintaining the internal air of a vehicle in a pleasant state.

On the other hands, a control system for vehicle air vents according the present disclosure has been made to softly discharge cool air or warm air discharged from an automotive air conditioning system (indirect cooling and heating) with a minimum discharge difference throughout a dashboard in the longitudinal direction, and to rapidly and efficiently cool and heat the entire internal of a vehicle.

First, as shown in FIG. 1, a control system for vehicle air vents according to an exemplary embodiment of the present disclosure includes a main vent 10, an assistant vent 20, and a controller 30.

FIG. 2A and FIG. 2B are views showing a main vent of the control system for vehicle air vents and the main vent 10 of the control system for vehicle air vents is described in detail with reference to FIG. 2A and FIG. 2B. The main vent 10 is formed to discharge conditioned air or formed to discharge cool air or warm air toward the lower portion of a driver or a passenger in the passenger seat. The main vent 10 may be positioned toward each of the driver seat and the passenger seat horizontally to the face of the driver or the passenger in the passenger seat to discharge conditioned air, cool air, or warm air directly toward the face of the driver or the passenger in the passenger seat.

The main vent 10 of the control system for vehicle air vents according to an exemplary embodiment of the present disclosure includes a main wing 11, a main gear 12, a main actuator 13, and a main lever 14.

The main wing 11 of the main vent 10 may be a blade positioned toward a discharge port through which air is discharged to discharge air in one direction thereof. The main wing 11 may include longitudinal wings 11a for discharging air in the left and right direction and a transverse wing 11b for discharging air in the up and down direction thereof. In detail, a through-hole is formed in a long slit shape (thin and long hole shape) in the up and down direction between the longitudinal wings 11a of the main wing 11, and at least one or more through-holes may be vertically formed and are rotated in the same direction thereof. The transverse wing 11b of the main wing 11 transversely connects the at least one or more longitudinal wings 11a vertically formed so that air which is discharged from the longitudinal wings 11a is intensively discharged in one direction of the upward direction and the downward direction thereof.

The main gear 12 of the main vent 10 is configured to rotate the main wing 11. The main gear 12 is coupled to the main actuator 13 to be described below and is configured to operate the main lever 14 coupled to the main wing 11.

The main actuator 13 of the main vent 10 is driven in response to an electrical signal from the controller 30 to be described below and is configured to operate the main gear 12. For example, the main actuator 13 is configured to adjust the angle of the main wing 11 by operating the main gear 12 when a signal giving an instruction to target the face of a driver is received from the controller 30.

The main lever 14 of the main vent 10 is coupled to the main wing 11 and the main gear 12 and is configured to rotate the main wing 11 by driving of the main actuator 13.

Meanwhile, the main gear 12, the main actuator 13, and the main lever 14 may be provided for each of the longitudinal wings 11a and the transverse wing 11b, and as described above, the longitudinal wings 11a may be coupled to the main gear 12, the main actuator 13, and the main lever 14 to rotate in the left and right direction and the transverse wing 11b may be coupled to the main gear 12, the main actuator 13, and the main lever 14 to operate in the up and down direction thereof.

FIG. 3A and FIG. 3B are views showing an assistant vent of the control system for vehicle air vents and the assistant vent 20 of the control system for vehicle air vents is described in detail with reference to FIG. 3A and FIG. 3B. The assistant vent 20, which is configured to additionally blow air into the interior of a vehicle, is formed, similar to the main vent 10, to discharge conditioned air or to discharge cool air or warm air. In detail, the assistant vent 20 includes an assistant wing 21, an assistant gear 22, an assistant actuator 23, and an assistant lever 24.

The assistant wing 21 of the assistant vent 20 is formed in a blade shape including a through-hole formed in a transversely long slit shape and may be formed in the same arrangement and shape as the transverse wing 11b described above.

The assistant gear 22 of the assistant vent 20 also, similar to the main gear 12, is configured to rotate the assistant wing 21 and is coupled to the assistant actuator 23, serving to operate the assistant lever 24.

The assistant actuator 23 of the assistant vent 20 is driven in response to an electrical signal from the controller 30 to be described below and is configured to drive the assistant gear 22. In detail, the assistant actuator 23 of the assistant vent 20 is electrically connected to the controller 30 and is configured to adjust the angle of the assistant wing 21 in response to a signal from the controller 30. For example, when a signal showing that the main vent 10 connected to the controller 30 is discharging air toward the face of a driver is received, the assistant actuator 23 is configured to control movement of the assistant gear 22 to adjust the angle of the assistant wing 21 so that air may be discharged toward the face of the driver.

The assistant lever 24 of the assistant vent 20 is coupled to the assistant wing 21 and the assistant gear 22 and is configured to rotate the assistant wing 21 in the up and down direction by the assistant actuator 23. The assistant wing 21 may be provided in a pair, and in the instant case, the assistant gear 22, the assistant actuator 23, and the assistant lever 24 are provided between the assistant wings 21 to be able to drive the pair of assistant wings 21.

The controller 30 of the control system for vehicle air vents according to an exemplary embodiment of the present disclosure collects state information by measuring the temperatures of the face and the body part of an occupant in a vehicle, collects internal image data of the vehicle using a visible light camera, and is configured to determine whether heat load has been generated based on the state information and the image data. Thereafter, the controller 30 is configured to adjust the angle of the main vent 10 based on heat load data, adjust the angle of the assistant vent 20 in accordance with the blowing direction of the main vent 10, and perform control so that any one of cool air or warm air is discharged from the main vent 10 and the assistant vent 20.

First, the controller 30 of the control system for vehicle air vents of the present disclosure is provided in a vehicle, obtains state information of occupants in the vehicle using an in-cabin monitoring system, and obtains internal image data using a driver monitoring system.

In-cabin monitoring systems include a camera that can measure a temperature information of passengers in the vehicle, and may collect a state information of an occupant, seat position of an occupant, seating state of an occupant, biometric information of an occupant and/or an occupant's face movement received through the camera.

Meanwhile, the controller 30 of the present disclosure may be positioned adjacent to a monitor to obtain state information and internal image data. The installation position of the controller 30 is not limited thereto and the controller 30 may be positioned in the dashboard in front of the steering wheel for a driver and may be provided in a monitor that outputs a navigation or a driving state. The controller 30 of the control system for vehicle air vents may be provided at any place in a vehicle as long as it is a place for obtaining the state information of an occupant and internal image data.

Meanwhile, the controller 30 of the control system for vehicle air vents detects state information of the occupant in the driver seat or the passenger seat or the occupant in the backseat and obtains internal image data of the vehicle.

In detail, the controller 30 of the control system for vehicle air vents detects all occupants in a vehicle, that is, detects at least one of the number of times of blinking of occupants, the open size of eyelids, or the movement speed of eyelids, detects the number of occupants, the positions of occupants, the postures of occupants, and behavior patterns of occupants by generating body skeletons in accordance with the shapes of the occupants, detects objects, identifies occupants in accordance with the characteristics of bodies, and detects characteristic behavior patterns of occupants. The state information collected by the controller 30 of the present disclosure includes the Heart Rate (HR) information of occupants and the HR information may include a Heart Rate Variability (HRV) signal.

The controller 30 can collect heat load data through at least one of an infrared camera or a visible light camera and use the heat load data as state information to determine whether an occupant has heat load. The controller 30 collects infrared, visible light, or far infrared information that reacts to the temperatures of the face and the body of an occupant and is trained based on heat load data.

Meanwhile, heat load data is extracted from the state information of a driver and all of passengers and image data of a vehicle that are collected by the controller 30 and is used for training. In detail, the controller 30 collects data as a learning model that utilizes any one algorithm of various algorithms such as a Convolution Neural Network (CNN) algorithm, a deep neural network (DNN), a Recurrent Boltzmann Machine (RNN), a Restricted Boltzmann Machine (RBM), a deep belief network (DBN), a Deep Q-Network, machine learning, or deep learning.

The controller 30 may be electrically connected to an external AI device or an AI device in a vehicle and may collect, store, and learn all of data obtained from occupants. In the instant case, the AI device is a computing device that can learn a neural network, and may be a server or may be various display devices that output the state information of a vehicle.

The controller 30 is configured to determine whether heat load has been generated by analyzing state information and internal image data and to drive the main vent 10 and the assistant vent 20 and is configured to control the angle of the assistant vent 20 that depends on adjustment of the angle of the main vent 10.

Hereafter, the order of determining whether heat load has been generated and operating the main vent and the assistant vent by the control system for vehicle air vents of the present disclosure is described in detail.

FIG. 4 is a block diagram showing the configuration of the control system for vehicle air vents according to an exemplary embodiment of the present disclosure, FIG. 5 is a flowchart sequentially showing the order of driving the control system for vehicle air vents according to an exemplary embodiment of the present disclosure, and FIG. 6A and FIG. 6B are views schematically showing an example in which the control system for vehicle air vents according to an exemplary embodiment of the present disclosure is driven.

First, the controller 30 of the control system for vehicle air vents according to an exemplary embodiment of the present disclosure includes an acquiring processor 31, a learning processor 32, an operating processor 33, a communication processor 34, and a control processor 35.

The controller 30 of the control system for vehicle air vents according to an exemplary embodiment of the present disclosure may be a program module of which at least some of the acquiring processor 31, the learning processor 32, the operating processor 33, the communication processor 34, and the control processor 35 communicate with an external system. The external system may include a communication service server or a base station. Such a program module may be included in the control system for vehicle air vents in an operating system type, an application program module type, or other program module types, and physically, may be stored in various well-known storage devices. Such a program module may be stored in a remote storage device that can communicate with the control system for vehicle air vents. Meanwhile, such a program module includes a routine, a subroutine, a program, an object, a component, a data structure, etc. That perform work or execute predetermined determination data types in accordance with the state information of all of occupants in a vehicle and internal image data in accordance with the present disclosure, but is not limited thereto.

Meanwhile, the control system for vehicle air vents was described above, the description is an example and it is apparent to those skilled in the art that, when necessary, at least some of the components or the functions of the control system for vehicle air vents may be implemented in an external system or may be included in an external system.

First, the acquiring processor 31 of the controller 30 of the control system for vehicle air vents of the present disclosure obtains state information of occupants in a vehicle and image data of the vehicle using at least one of an infrared camera or a visible light camera. In detail, the acquiring processor 31 collects infrared and visible light data depending on body temperatures of all of occupants (including a driver) in a vehicle, obtains data about temperatures of faces and body portions and heart rates and the postures and behavior patterns of the occupants, and collects information related to feelings and facial expressions.

The learning processor 32 of the controller 30 of the control system for vehicle air vents of the present disclosure is configured to analyze heat load in the state information and the image data obtained from the acquiring processor 31. Depending on embodiments, it may be possible to analyze whether a driver is dozing or watching a mobile phone by analyzing the positions of the driver's eyes, analyze whether passengers are women, men, or children based on information related to the number, position, and size of the passengers, determine what feelings the passengers have by analyzing state information related to behavior patterns and postures of respective the passengers, and analyze what state the passengers are in by determining habits and measuring heart rates.

The learning processor 32 of the controller 30 of the control system for vehicle air vents of the present disclosure learns previously stored data and the state information, image data, and heat load data obtained from the acquiring processor 31. The previously stored data is previously extracted data and is stored by extracting feature values from state information, image data, and heat load data.

Meanwhile, a learning model is provided in the learning processor 32 and it is possible to determine whether heat load is currently generated in a vehicle using a deep learning algorithm based on previously stored data and currently obtained data.

Depending on embodiments, it is possible to determine the status of passengers and analyze the features or habits of predetermined driver or passengers.

Next, the operating processor 33 of the control system for vehicle air vents of the present disclosure drives the air vent control system based on heat load data of a driver extracted from the learning processor 32. For example, when it is determined that the currently measured temperature of the face of a driver is high, i.e., higher than a predetermined temperature, in data extracted from the learning processor 32, the operating processor 33 adjusts the angles of the main vent and the assistant vent of air vents so that cool air is blown to the driver's face. On the other hand, when it is determined that the currently measured temperature of the face of a driver is low, the operating processor 33 adjusts the angles of the main vent and the assistant vent so that warm air is blown to the driver's face.

Meanwhile, the main vent and the assistant vent of the present disclosure are moved in the same direction thereof. For example, when the main vent of air vents blows air to the face of a driver or a passenger, the angle of the assistant vent is also adjusted in the same direction as the main vent. The operating processor 33 of the present disclosure blows air to the face of a driver or a passenger in a cooling mode or a mild mode. In a heating mode, the operating processor 33 blows warm air into the entire vehicle so that warm air is not discharged to the face of a driver or a passenger and air circulates in the vehicle.

The communication processor 34 of the control system for vehicle air vents of the present disclosure enables transmission and reception of data with the acquiring processor 31, the learning processor 32, the operating processor 33, and the control processor 35.

The control processor 35 of the control system for vehicle air vents of the present disclosure can perform a function of controlling data flow between the acquiring processor 31, the learning processor 32, the operating processor 33, and the communication processor 34. That is, the control processor 35 according to an exemplary embodiment of the present disclosure is configured to control data flow from the outside of the control system for vehicle air vents or data flow between components, whereby the control processor 35 can control the acquiring processor 31, the learning processor 32, the operating processor 33, and the communication processor 34 so that they perform their own functions.

In an exemplary embodiment of the present disclosure, the acquiring processor 31, the learning processor 32, the operating processor 33, and the communication processor 34 may be embodied in a single processor or separately.

The order of driving the control system for vehicle air vents of the present disclosure is sequentially described hereafter.

FIG. 5 is a flowchart sequentially showing the order of driving the control system for vehicle air vents according to an exemplary embodiment of the present disclosure and FIG. 6A and FIG. 6B are views schematically showing an example in which the control system for vehicle air vents according to an exemplary embodiment of the present disclosure is driven.

As shown in FIG. 5, the control system for vehicle air vents according to an exemplary embodiment of the present disclosure first activates an air conditioning mode for a vehicle (\textcircled{1}). Thereafter, the control system obtains state information of a driver and passengers and image data using at least one of an infrared camera or a visible light camera (S110). The control system extracts heat load data using any one learning model of a convolution neural network algorithm or a deep learning algorithm described above to analyze the state information and image data. When concluding that heat load has been generated, the control system drives air vents and controls the angles of the main vent and the assistant vent (S120). Next, the control system checks whether the main vent is driven toward the face of a driver (S130). When the main vent is operated toward the face of the driver, the control system checks whether a heat load mode or a mild mode is in operation (S140). When it is determined that the main vent is not operated toward the face, a direct mode is entered. The direct mode is a mode in which air is discharged toward the face of a driver or a passenger by adjusting the angles of the main vent and the assistant vent of the air vents. When concluding that the main vent is operated toward the face of the driver or the passenger, the control system checks whether air is discharged through a crash pad vent (S150). However, when concluding that air is not discharged through the crash pad vent, the control system activates the direct mode (S160). Meanwhile, when concluding that air is discharged through the crash pad vent, the control system changes the mode into a face target mode.

The control system for vehicle air vents according to an exemplary embodiment of the present disclosure extracts state information of a driver and passengers and image data and checks whether a heat load cooling mode or a mild mode is operated by the data. A cooling mode is configured to have a discharge temperature relatively lower than that of a mild mode.

Thereafter, when the main vent is operated toward the face of a driver, the control system checks whether the heat load cooling mode or the mild mode is operated, and when the main vent is operated toward the face of a driver, the control system checks also whether air is discharged through the crash pad vent and then changes the mode into the face target mode (\textcircled{2}). When the main vent is not operated toward a face, the heat load cooling mode or the mild mode is not operated, or air is not discharged through the crash pad vent, the direct mode may be activated.

Next, the control system for vehicle air vents according to an exemplary embodiment of the present disclosure may extract state information of a driver and passengers and image data and then immediately enter the face target mode (\textcircled{3}) when a driver is determined to be drowsy through the controller.

While the main vent and the assistant vent discharges cool air or warm air except for the face of a driver or a passenger (\textcircled{1}, \textcircled{2}), as shown in FIG. 6A, when the face target mode is activated (\textcircled{1}), as shown in FIG. 6B, the control system may be driven in the face target mode (\textcircled{1}) in the cooling and mild modes. In a heating mode, the control system blows warm air indirectly except for the face of a driver or a passenger \textcircled{2}.

Hereinabove, although the present disclosure was described by specific matters such as concrete components, and the like, embodiments, and drawings, they are provided only for assisting in the entire understanding of the present disclosure. Therefore, the present disclosure is not limited to the embodiments. Various modifications and changes may be made by those skilled in the art to which the present disclosure pertains from the present description.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A control system for vehicle air vents, the control system comprising:
a main vent positioned in a vehicle and configured to discharge air;
an assistant vent positioned over the main vent; and
a controller configured to drive at least one of the main vent and the assistant vent,
wherein the controller is configured to determine heat load data generated in the vehicle, to adjust an angle of the main vent, and to adjust an angle of the assistant vent based on a blowing direction of the main vent.

2. The control system of claim 1, wherein the controller is further configured to collect the heat load data through at least one of an infrared camera and a visible light camera.

3. The control system of claim 1, wherein the controller is further configured to utilize at least one of an in-cabin monitoring system or a driver monitoring system.

4. The control system of claim 1, wherein the controller is further configured to collect state information by measuring temperatures of faces and body portions of occupants in the vehicle using an infrared camera and to collect internal image data of the vehicle using a visible light camera.

5. The control system of claim 1, wherein the controller includes:
an acquiring processor configured to obtain state information of occupants in the vehicle and image data of the vehicle using at least one of an infrared camera and a visible light camera;
a learning processor configured to determine and learn whether heat load has been generated from the state information and the image data obtained from the acquiring processor; and
an operating processor configured to adjust the angle of the main vent based on the heat load data and adjust the angle of the assistant vent based on the angle of the main vent.

6. The control system of claim 5, wherein the controller further includes a control processor configured to drive the operating processor and to control data flow between the acquiring processor, the learning processor, and the operating processor, and a communication processor configured to communicate with an external device.

7. The control system of claim 5, wherein the learning processor is further configured to collect data as a learning model that utilizes any one algorithm of a Convolution Neural Network (CNN) algorithm, a machine learning algorithm, or a deep learning algorithm.

8. The control system of claim 5, wherein the learning processor is further configured to extract feature values from the state information, the image data, and the heat load data obtained from the acquiring processor, and to store and utilize the feature values as previously stored data.

9. The control system of claim 4, wherein the state information includes at least one of a number of times of blinking of an occupant, an open size of eyelids of the occupant, or a movement speed of eyelids of the occupant.

10. The control system of claim 5, wherein the state information includes heart rate (HR) information of an occupant obtained from the acquiring processor and the heart rate information includes a heart rate variability (HRV) signal.

11. The control system of claim 4, wherein the state information includes information recognizing a posture and a behavior pattern of an occupant, and detecting and a position of an object.

12. The control system of claim 1,
wherein the main vent includes:
a main wing being a blade positioned in a discharge port configured to discharge air to determine a direction of air;
a main gear engaged to the main wing and configured to rotate the main wing;
a main actuator coupled to the main gear and electrically connected to the controller and configured to drive the main gear; and
a main lever coupled to the main wing and the main gear and configured to rotate the main wing by driving of the main actuator, and
whether the angle of the main vent is adjusted by an electrical signal from the controller.

13. The control system of claim 12, wherein the main wing of the main vent includes:
at least one or more vertically disposed longitudinal wings; and
a transverse wing transversely connecting the at least one or more vertically disposed longitudinal wings.

14. The control system of claim 1,
wherein the assistant vent includes:
an assistant wing being a blade positioned in a discharge port configured to discharge air to determine a direction of air;
an assistant gear coupled to the assistant wing and configured to rotate the assistant wing;
an assistant actuator coupled to the assistant gear and electrically connected to the controller and configured to drive the assistant gear; and
an assistant lever coupled to the assistant wing and the assistant gear and configured to rotate the assistant wing by driving of the assistant actuator, and
wherein the angle of the assistant vent is adjusted based on the angle of the main vent.

15. The control system of claim 1, wherein the controller is further configured to activate a face target mode, in response that the main vent is operated toward a face of an occupant, the control system is in a heat load mode or a mild mode, and air is discharged through a crash pad vent of the vehicle.

16. The control system of claim 15 wherein the controller is further configured to activate a direct mode, in response that the main vent is not operated toward the face of the driver, the control system is not in the heat load mode or the mild mode, and the air is not discharged through the crash pad vent.

17. A control method of the control system of claim 1, comprising:
activating, by the controller, a face target mode, in response that the main vent is operated toward a face of an occupant, the control system is in a heat load mode or a mild mode, and air is discharged through a crash pad vent of the vehicle.

18. The control method of the control system of claim 17, further including:
activating a direct mode, in response that the main vent is not operated toward the face of the driver, the control system is not in the heat load mode or the mild mode, and the air is not discharged through the crash pad vent.
